(19) United States
(12) Patent Application Publication
(10) Pub. No.: US 2009/0138406 A1
(43) Pub. Date: May 28, 2009

(54) SYSTEM AND METHOD FOR PROVIDING A TARGET SPENDING PORTFOLIO

(75) Inventors: Patrick Reinkemeyer, Lake Forest, IL (US); Maciej Kowara, Downers Grove, IL (US)

Correspondence Address: K&L Gates LLP, P.O. Box 1135, CHICAGO, IL, 60690, US

(73) Assignee: Morningstar Inc., Chicago, IL (US)

(21) Appl. No.: 11/945,102

(22) Filed: Nov. 26, 2007

(51) Int. Cl. G06Q 40/00

(52) U.S. Cl. 705/36 R

(57) ABSTRACT

A system or method for administering an investment portfolio which assists investors in managing their assets and converting those assets to income. The investment portfolio of the present disclosure is designed to pay back the investor's principal and earnings over the portfolio's term. In this manner, the investment portfolio provides a more attractive way to sustain purchasing power than yield-oriented investments.

### COPYRIGHT NOTICE

A portion of the disclosure of this patent document contains material which is subject to copyright protection. The copyright owner has no objection to the photocopy reproduction of the patent document or the patent disclosure in exactly the form it appears in the Patent and Trademark Office patent file or records, but otherwise reserves all copyright rights whatsoever.

### BACKGROUND

Many people are heading toward retirement years and are moving from accumulating assets to drawing down their accumulated assets. In retirement, investors often need to receive a stream of periodic payments from their investments to pay their living expenses. Many such investors are concerned about outliving their assets and being able to maintain their standard of living. Despite concerns around longevity risk and not having enough assets in retirement, many investors are wary of annuities. In particular, many people in the large group of people often called baby boomers who are in or about to enter retirement are wary of annuities.

Annuities are a well-known investment vehicle for providing a stream of regular payments. An annuity is funded with an initial principal amount, commonly termed a contract amount, from an investor. The annuity makes periodic payments to the investor (often called the annuitant), based on the contract amount, and the number of payments that are anticipated to be made from this annuity. Annuities are available in many forms. For example, certain known annuities make the distributions for a predetermined definite period (as in an annuity certain) and other known annuities make the distributions for as long as the person lives (as in a life annuity).

More specifically, in a straight life annuity, payments typically terminate on the annuitant's death. In a life annuity with period certain, payments may continue to a beneficiary for a specified period after the annuitant's death. In an immediate annuity, an annuitant generally begins receiving payments about a month after purchasing the annuity. This type of annuity offers financial security in the form of income payments for the rest of the annuitant's life. In a deferred annuity, the annuitant begins to receive payments after a specified amount of time. The cash value of an annuity is the commuted value of benefits payable irrespective of whether the annuitant is still alive.

As with most investments, there are risks associated with annuities. In a life annuity, in which payments are made until the death of the annuitant, there is a risk to the entity providing or guaranteeing the annuity that the annuitant will live longer than anticipated or expected (at the start of the annuity). This risk can cause the entity providing or guaranteeing the annuity to reduce the amount of periodic payments driven by a continuing reduction of the principal amount to provide these payments. In a life annuity, there is also a risk to that for the annuitant because the annuitant may live a lesser time than anticipated or expected (at the start of the annuity) and thus not receiving a sufficient number of payments to have justified the initial investment in the annuity.

These risks are compounded by the risks associated with future economies. In a booming economy, the principal amount may provide a return-on-investment that exceeds the rate at which the periodic payments diminish the principal amount. In an inflationary economy, the value of the periodic payments may be insufficient to meet the intended need for these payments. Similarly, in a depressed economy, the return-on-investment may not be sufficient to match the rate at which the periodic payments diminish the principal amount.

In a conventional fixed life annuity plan, the provider or guarantor of the annuity plan assumes most of the long-term risks. The annuitant is guaranteed a level payment amount for the duration of the annuitant's life or, if there are multiple annuitants, for the duration of the annuitants' lives. If the guarantor is able to invest the contract amount at a higher rate-of-return than the rate-of-depletion of the principal by the periodic payments, the guarantor earns a profit. If the annuitant dies before the principal is depleted, the provider or guarantor also earns a profit. If the principal is depleted before the annuitant dies, the subsequent periodic payments are borne by the provider or guarantor, at a loss to the provider or guarantor. Fundamentally, a fixed annuity alleviates the investor of the risk of outliving the source of income from the investment.

Although typical investors may desire to shift the long-term risk to the provider or guarantor via a fixed annuity plan, such investors are often unwilling to assume the risk of losing the investment based on the short-term risk of dying prematurely. In a fixed life annuity, when the investor dies, the investor's beneficiaries are deprived of the investment amount, which they would have received if the annuity had not been purchased. To increase the marketability of a fixed life annuity, certain conventional fixed annuity plans offer a guaranteed minimum payment amount and duration (sometimes referred to as certain period or inheritance period), independent of the annuitant's life, to offset this reluctance on the part of the investor to assume the short-term risk of a loss of investment. If the annuitant dies prematurely, the provider or guarantor continues to provide the guaranteed number of payments to the designated beneficiaries of the annuitant.

A fixed annuity, however, does not protect an investor from the long-term risk of inflation causing the periodic payments to lose purchasing value. To offset this risk, certain conventional annuity plans offer a guaranteed payment amount that is dependent upon an annually determined inflation rate. To offset the assumption of this additional risk, the initial payment amounts are generally slightly less than the payment amounts of a conventional fixed life annuity plan. In both the fixed life annuity and the annuity with inflation protection, the provider or guarantor assumes the long-term risks, and correspondingly, enjoys the benefits of any long-term gains. For example, a typical annuity may be based on an effective annual interest rate of five percent (5%). If the provider or guarantor is able to earn a long-term return-on-investment of eight percent (8%), this additional three percent (3%) is profit to the guarantor. Because of the relatively low guaranteed interest rate provided by a fixed annuity, compared to potential rates of return on investments, relatively few fixed annuity plans arc sold during periods of high investment return potential.

To offset the loss of sales in fixed annuities during periods of economic growth, certain providers or guarantors, such as insurance companies, offer variable annuity plans. In a variable annuity plan, the investor chooses from a variety of investment options, such as mutual funds, and the periodic payment generally is based on the current value of each of the selected options. The investor assumes the long-term market risks, and the provider or guarantor of the annuity provides administrative services. In a conventional variable annuity, the payment amount is adjusted periodically, based on the current value of the investment. All of the gains realized by a favorable market, if any, are credited to the investor because the investor assumes all of the risks. Correspondingly, all losses, if any, are deducted from the investor's principal. The periodic payments will vary depending upon increase or decrease in the value of the investments.

In a variable annuity, the investor assumes the long-term risk of diminishing the principal to such an extent that the periodic payments are substantially decreased, and also assumes the short-term risk of reduced payments during periods of a depressed market. In a rapidly changing economy, the fluctuation in payment amounts can be disconcerting or, more significantly, may not provide the amount required to meet the needs for which the annuity was established.

Hybrid variable-rate annuities are also available at an additional cost to the investor. In a hybrid variable-rate annuity, the annuity is guaranteed not to decrease below a minimum payment amount. In such a annuity, the provider or guarantor is assuming some of the long-term risk in return for the additional cost to the investor. In a hybrid variable-rate annuity, the minimum payment amount is often substantially lower than the payment amount that is provided in periods of high investment return.

Providing a minimum payment amount in hybrid variable-rate annuities does not eliminate the fluctuations in payment amounts that are based on the current profits or losses provided by the investment. The fluctuations in payment amounts can be controlled somewhat by “filtering” the present investment value that is used to determine the annuity payments. For example, a running average of the present value of the investment may be used to eliminate very short-term peaks and dips from the value used to determine the annuity payments. Using a running average to determine the annuity payments average generally “lags” the present investment value such that general increases or decreases are not immediately reflected in the average. Hence, the increase or decrease in the annuity payment is delayed relative to the actual increase or decrease in the investment value. This can be problematic when investments are performing poorly, which results in the annuity payments being higher than the actual investment value warrants. This causes the investment to be depleted at a faster rate than the investment value can actually sustain.

Notwithstanding the above generally described known annuity products and options, there is a need for a system and method for administering an investment product which provides an investor: (1) the opportunity for increased payout amounts during periods of favorable investment performance; (2) a cushion against inflation; (3) the ability to enter/exit the investment contract as desired; and (4) the ability to maintain control of assets for the investor's estate or beneficiaries.

### SUMMARY

Various embodiments of the present disclosure provide a system and method for administering an investment product, generally referred to herein as a “target spending portfolio.” The target spending portfolio of the present disclosure assists investors in managing their assets and converting those assets to income. The target spending portfolio enables investors to systematically draw down the assets in an investment account to zero over a designated investment term which ends at a final payout date. The target spending portfolio provides periodic payouts of the investor's principal and earnings over the term of the portfolio. In this manner, the target spending portfolio of the present disclosure provides a more attractive way to sustain purchasing power than yield-oriented investments. It should be appreciated that, in various embodiments, the target spending portfolio may be applied to investment portfolios having any suitable asset allocation and any suitable legal structure, such as a mutual fund, separate account, etc.

In one embodiment, the investment term of the target spending portfolio includes a predetermined number of designated time periods. For each designated time period, the payout provided to the investor is adjusted to accomplish depleting the investment account over the term of the portfolio. By the end of the investment term, the balance in the investor's account will be equal to zero, and the investor will have drawn out the entire amount of the portfolio's assets, including principal and earnings. For example, if in 2007 an investor purchases a target spending portfolio with a twenty-year investment term, the portfolio's assets and any earnings will be depleted and paid out to the investor by 2027.

In various embodiments discussed herein, the annual payouts are provided to the investor based on a determined sustainable spending rate (“SSR”). The SSR is determined based at least on the amount of money in the investor's account at each designated time period (for each designated upcoming payout period) and the amount of time left until the end of the portfolio's term (i.e., the final payout date). The SSR is a spending rate that the portfolio should be able to sustain with a given or designated level of confidence until the final payout date.

In general, one embodiment of the computerized method of administering the target spending portfolio includes:
(a) forming an agreement between an administrator and an investor which establishes the target spending portfolio for an investment term;
(b) obtaining relevant information from the investor, if necessary;
(c) establishing an investment account for holding funds for the benefit of the investor;
(d) accepting funds from the investor and depositing those funds into the investment account;
(e) investing the deposited funds;
(f) determining, for a first designated time period, an SSR based at least in part on the current investment account value and the time remaining until a final payout date;
(g) providing one or more payouts to the investor from the investment account, wherein the total payout amount is based on the determined SSR for the designated time period;
(h) at or close to the end of the designated time period, determining an actual performance rate for the target spending portfolio;
(i) re-calculating the SSR based on the actual performance rate of the target spending portfolio and time remaining until the final payout date;
(j) applying the re-calculated SSR to a next designated time period to determine one or more payouts to be provided to the investor for that next designated time period;
(k) repeating (g) to (j) until a final designated time period; and
(l) for the final designated time period, determining a final payout amount to be provided to the investor such that, after the final payout amount is provided to the investor, the investment account value is zero.
   It should be appreciated that in other embodiments, one or more of these steps can be varied in accordance with the present disclosure. For example, in one embodiment, if there is any money left over at the end of the investment term, it is paid out to the investor in the final payout.

In one such embodiment, the SSR is determined at the beginning of each time period. The SSR is re-calculated at or near the end of each time period based on the portfolio's performance and the amount of time remaining in the investment term. In an alternative embodiment, the SSR is re-calculated immediately after or shortly after the end of each time period. In one example embodiment, each designated time period includes a year (such as a calendar year), and the SSR is determined at the beginning of each year. The SSR remains at the determined rate for the 12 months of that year. At each year-end, the SSR is re-calculated based on the portfolio's performance and the number of years remaining in the investment term. It should be appreciated that the SSR can change for each time period based on the investment performance of the portfolio and its ever-shortening investment horizon.

The periodic change of the SSR reduces both the risk of the running out of money (i.e., spending or paying out too much), as well as not increasing spending to keep pace with inflation (i.e., spending or paying out too little). It should be appreciated that the amount of the periodic payout may increase or decrease in absolute dollars based on market performance. The ability to increase both the payout rate and the dollar amount of the payout provides investors with protection against inflation.

Accordingly, one advantage of the present disclosure is to provide a method or system for administering an investment portfolio which enables investors to draw down the assets in an investment account in a thoughtful and predictable way.

Another advantage of the present disclosure is to provide a method or system for administering an investment portfolio which offers a retirement distribution strategy that is easy to understand and implement.

Another advantage of the present disclosure is to provide a method or system for administering an investment portfolio which provides a high-probability, disciplined spending rate paid out over a designated investment term.

Another advantage of the present disclosure is to provide a method or system for administering an investment portfolio which provides increased payment amounts during periods of favorable investment performance.

Another advantage of the present disclosure is to provide a method or system for administering an investment portfolio which provides flexibility and liquidity by enabling investors to enter or exit the contract as desired.

Another advantage of the present disclosure is to provide a method or system for administering an investment portfolio which reduces the impact of inflation by providing the ability to increase the annual payout amount.

Another advantage of the present disclosure is to provide a method or system for administering an investment portfolio which provides control of assets for the investor's estate or beneficiaries.

Another advantage of the present disclosure is to provide a method or system for administering an investment portfolio having the transparency and safeguards of an SEC registered open-end mutual fund.

Another advantage of the present disclosure is to provide an investment portfolio which offers on-going professional asset management with a total-return, not just income, investment goal.

Further features and advantages of the present disclosure, as well as the structure and operation of various embodiments of the present disclosure, are described in detail below with reference to the accompanying drawings.

### BRIEF DESCRIPTION OF THE FIGURES

FIG. 1 is a flow diagram illustrating one embodiment of the method or system of administering the target spending portfolio of one embodiment of the present disclosure.

FIG. 2 is a diagram illustrating one example delivery system for the target spending portfolio of the present disclosure.

FIGS. 3A, 3B, and 3C are example tables which illustrate how the sustainable spending rate (SSR) of the target spending portfolio may change annually based on investment performance and the ever-shortening investment horizon.

FIG. 4 is an example graph illustrating the ability of the target spending portfolio of the present disclosure to maintain purchasing power over time compared to a single premium immediate annuity.

FIG. 5 is an example table describing key differences between the target spending portfolio of the present disclosure and other types of investment products.

### DETAILED DESCRIPTION

Various embodiments of the present disclosure relate to systems and methods for administering a target spending portfolio. The target spending portfolio of the present disclosure enables investors to systematically draw down the assets in an investment account to zero over a designated investment term.

It should be appreciated that the method of the present disclosure, or one or more steps of the method of the present disclosure, are configured to be implemented by one or more conventional computer-based systems including one or more processors, one or more memory devices, one or more input devices, one or more display devices, one or more output devices (such as printers or data storage devices) and other suitable components. It should be also be appreciated that the present disclosure completes a system including such components for performing the method or one or more steps of the method disclosed herein. It should further be appreciated that such computer systems can be accessed through suitable data networks such as the Internet or through the intranet or extranet of one or more entities. It should also be appreciated that one or more steps of the method or components of the system can be performed by the same system or entity or can be preformed by two or more different systems or entities.

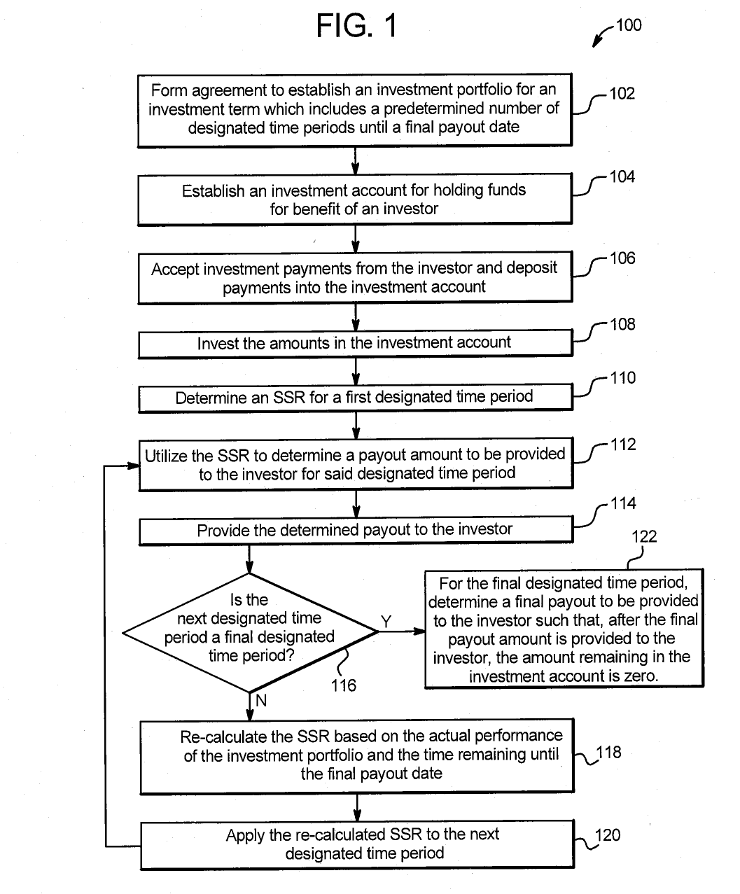

Referring now to FIG. 1, one method of administering the target spending portfolio operates according to sequence 100. An agreement is entered into by an administrator and an investor in a typical manner as indicated by block 102. The agreement establishes the target spending portfolio for an investment term. The investment term includes a predetermined number of designated time periods, such as a number of years, and lasts until a final payout date. In certain embodiments, prior to or during the process of establishing the agreement, the administrator acquires information from the investor, including the investor's name, address, social security number, and any other suitable personal and/or financial information.

After the investor and administrator have entered into an agreement, an investment account is established for holding funds for the benefit of the investor as indicated by block 104. The administrator accepts funds from the investor and deposits those funds into the investment account as indicated by block 106. In different embodiments, the investor may provide the funds either periodically or in a lump sum.

In the illustrated embodiment, after the investor's funds are deposited into the account, the deposited funds are invested as indicated by block 108. In certain embodiments, the funds are invested according to a strategic asset allocation plan, which includes a fixed-income portion as well as an equity portion. In one embodiment, the portfolio's asset allocation is required to fall within a designated range that is determined to be prudent, such as from 40% to 60% equities. This helps to help minimize the variability of payouts. The investment allocation plan typically strives for broad market coverage and diversification by asset class, style within asset class geographical region, sector, and manager. For example, equity may be split between domestic (70%-75%) and international (25%-30%). The fixed-income portion, in one embodiment, is also broadly diversified, targeting a mix of high-quality domestic bonds, high-yield bonds, international developed bonds, TIPS, and emerging-markets debt.

In one embodiment, the investor's funds are invested by purchasing shares in a mutual fund. In such an embodiment, the investor has the benefit of investing a larger sum of money with a group of investors. Such an investment strategy may provide lower associated costs and larger returns. In another embodiment, an individual has his or her own fund or portfolio.

In various embodiments, the target spending portfolio administrator conducts portfolio construction at the underlying-holdings level. The administrator examines the securities in any underlying funds and measures the asset-class and style exposures based on aggregating the underlying securities from each of the component funds. Since investment selection plays a major role in the long-term returns of a portfolio, the investment-selections process combines three components: (1) quantitative analysis; (2) qualitative research; and (3) determination of fit within the portfolio. Quantitative analysis includes various screens and scores. For example, in one embodiment, qualitative research includes analyzing mutual funds and thousands of money managers. Determining the fit of each fund ensures that each fund fits well stylistically with other investments in the portfolio. It should be appreciated that other suitable methods can be employed in accordance with the present disclosure.

Turing back to the flowchart, a sustainable spending rate (“SSR”) is determined for a first designated time period as indicated by block 110. The SSR is the spending rate that the portfolio should be able to sustain with a given level of confidence until the end of the portfolio's term or the final payout date. More specifically, the SSR determines the amount of inflation-adjusted dollars that can be paid out for each designated time period for the remaining life of the portfolio. In one embodiment, the SSR is determined at the beginning of the designated time period. In one example embodiment, the designated time period is a year, and the SSR is determined at the beginning of the year. The SSR remains at that rate for the next 12 months of the year.

The SSR is used to determine a payout amount which will be provided to the investor for the designated time period as indicated by block 112. In certain alternative embodiments, the portfolio's asset allocation is revisited periodically, such as monthly, to ensure that the portfolio is on track to meet the current time period's determined payout amount.

The determined payout amount is provided to the investor as indicated by block 114. In one embodiment, the payout amount is provided to the investor all at once for the designated time period. In another embodiment, the payout amount for the time period is paid out in increments. For example, in one embodiment where each designated time period is a year, the determined payout for the year is divided by 12 and paid out to the investor in 12 monthly installments. In certain embodiments, investors may suspend payouts in the first year of the investment portfolio to take advantage of the different tax rates between short term games and long term gains.

It should be appreciated that that the payout amount is only an estimate of the amount that could be sustained for the life of the portfolio. The payout amount must be appropriate, in view of the market and the underlying funds. Therefore, in certain embodiments, a payout amount for a designated time period which is initially set based on the SSR may be adjusted based on other qualitative considerations. For example, during a period of extreme market uncertainty (or uncertainty regarding the underlying funds), the payout amount for a designated time period may be reduced from the payout amount which is determined based on the SSR calculation. In certain embodiments, the payout amount may be determined and reset more often than once per designated time period.

If there is another designated time period remaining in the investment term which is not a final designated time period, the SSR is recalculated based on the performance of the investment portfolio and the time remaining until the final payout date, as indicated by diamond 117 and block 118, respectively. The re-calculated SSR is applied to the next designated time period, as indicated by block 118. The process continues starting at block 112 until a final designated time period.

As indicated by block 122, for the final designated time period, a final payout which will be provided to the investor is determined, such that after the final payout is provided to the investor the balance in the investment account will be equal to zero. That is, by the end of the investment term (i.e., by the final payout date), the investor will have drawn out the entire amount of the portfolio's assets.

In one embodiment, as the investment term approaches the final payout date, the SSR is determined more frequently to ensure the portfolio's life and to avoid an unduly large or small terminal payment. For example, in the last 24 months of a 20-year target spending portfolio, the SSR is may be determined every 6 months rather than every 12 months.

It should be appreciated that any suitable equation or method may be used to determine the SSR. To illustrate one equation used to determine the SSR, the following example assumes an investor has $1 and wants to know how much he can spend per year in years 1 through N, if the initial $1 is invested in an investment portfolio with annual returns of r₁, r₂, . . . , r_{N}. The investor can spend s per year if the investor's final wealth at the end of year N is zero. This means solving the following equation:

( . . . (1+r₁)−s)(1+r₂)−s) . . . (1+r_{N})−s=0.

Moving s to the other side of the equation and dividing by (1+r_{N}) results in the following equation:

( . . . (1+r₁)−s)(1+r₂)−s) . . . (1+r_{N-1})−s=s/(1+r_{N}).

Continuing this way, the equation becomes:

1=[s/(1+r₁)]+[s/(1+r₁)(1+r₂)]+ . . . +[s/(1+r₁)(1+r₂)(1+r_{N})]

from which comes the equation:

$$s = \frac{1}{\frac{1}{( 1 + {r}_{1} )} + \frac{1}{( 1 + {r}_{2} ) ( 1 + {r}_{1} )} + … + \frac{1}{( 1 + {r}_{2} ) ( 1 + {r}_{1} ) ) … ( 1 + {r}_{N} )}}$$

which is equivalent to:

$$s = \frac{( 1 + {r}_{2} ) ( 1 + {r}_{1} ) ) … ( 1 + {r}_{N} )}{\begin{matrix}( 1 + {r}_{2} ) ( 1 + {r}_{3} ) … ( 1 + {r}_{N} ) + \\ ( 1 + {r}_{3} ) … ( 1 + {r}_{N} ) + … + ( 1 + {r}_{N} ) + 1\end{matrix}} .$$

In one embodiment, a Monte Carlo simulation is used to determine or calculate the SSR. The Monte Carlo simulation incorporates estimates for capital markets' returns and volatility to determine how much money can be paid out to an investor from an investment portfolio, in equal installments that occur at designated time intervals, such that the investor will draw down the assets in the investment portfolio to zero by the final payout date and have an X % chance to be able to sustain those withdrawals throughout, given the investment portfolio's asset allocation, asset base, and final payout date. The choice of the probability confidence parameter, X, is governed by the goal of minimizing the variability of payments throughout the withdrawal period. In one embodiment, the investor may choose the probability confidence parameter which is utilized to determine the SSR based on the investor's preferred level of investment risk. In one example, the probability confidence parameter is greater than 50%. In another example, the probability confidence parameter is in a range of 50% to 70%. In another example, the probability confidence parameter is approximately 60%. It should thus be appreciated that the probability confidence parameter can be any suitable desired amount. It should also thus be appreciated that in various embodiments, the SSR is a function with five variables including: (i) the asset base; (ii) the time until final payout date; (iii) the risk and reward profile of the investment portfolio; (iv) the probability confidence parameter X; and (v) the frequency of payouts. The SSR function returns the amount to be spent as a percentage of the asset base.

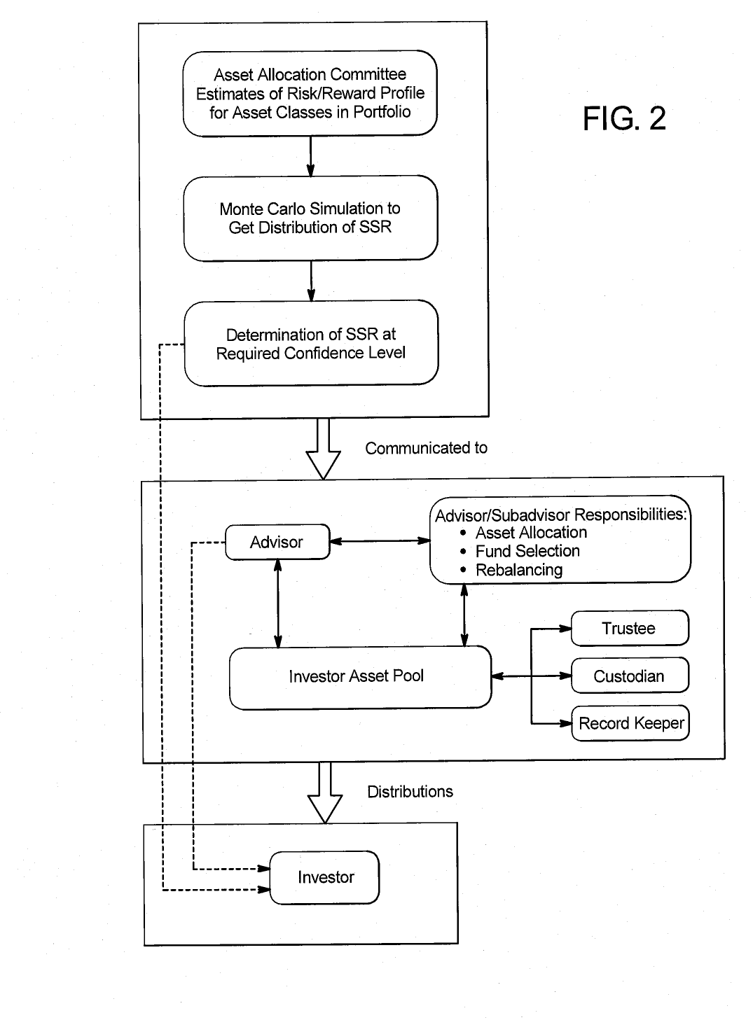

Referring now to FIG. 2, one example delivery system for the target spending portfolio of the present disclosure is provided. In this example, an investor enters into an agreement with an advisor or administrator to establish a target spending portfolio for a designated investment term. The investor provides funds which are held in an investment account or investor asset pool. The advisor is responsible for maintaining the investment portfolio by conducting asset allocation, fund selection, and rebalancing.

In the example of FIG. 2, an asset allocation committee obtains estimates of the risk and reward profiles for the asset classes of the portfolio. These estimates are input into a Monte Carlo simulation to obtain a distribution of the SSR. Based on output of the Monte Carlo simulation, an SSR is determined or selected at a required confidence level. For example, 1000 different market paths are simulated using the Monte Carlo Simulation, and the value that is likely to result in 60% chance of success is selected for the SSR. Once an appropriate SSR is determined for the investment portfolio, the SSR is communicated to the advisor. The advisor utilizes the determined SSR to establish the payout amount which will be provided to the investor. The advisor provides appropriate distributions to the investor based on the determined payout amount. Thus, in such an embodiment, the advisor or administrator obtains the SSR from a different entity. In other embodiments, the administrator determines the SSR.

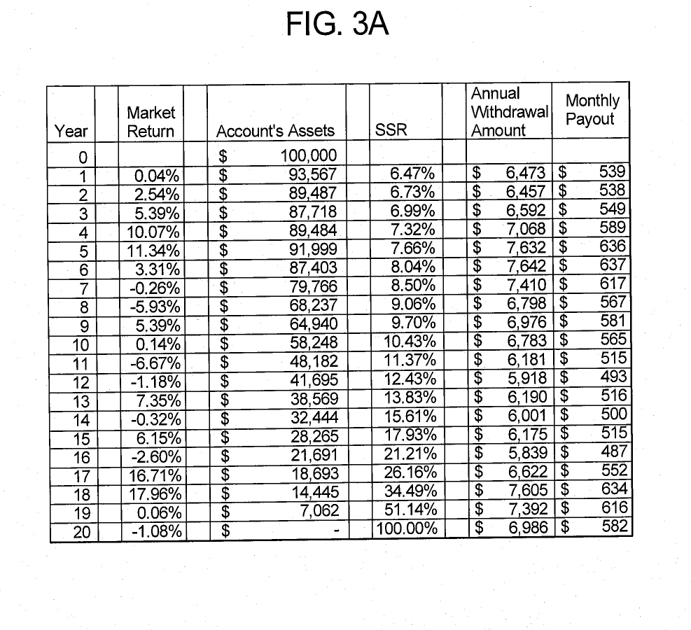

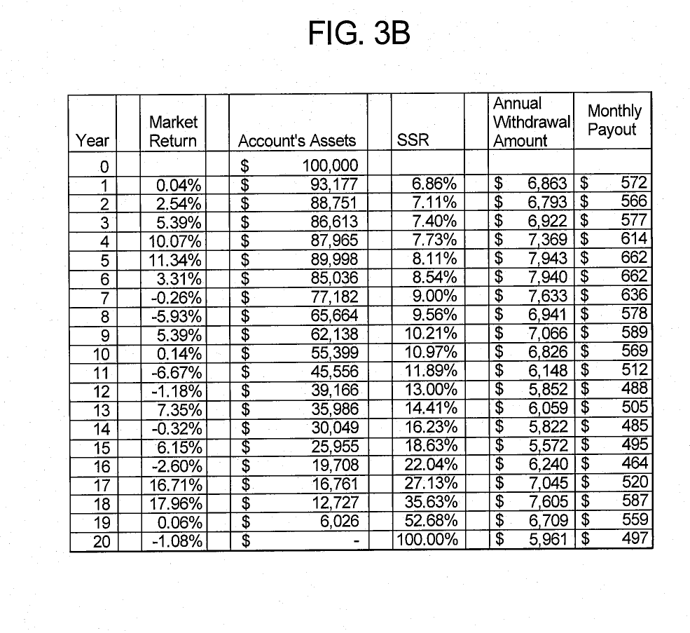

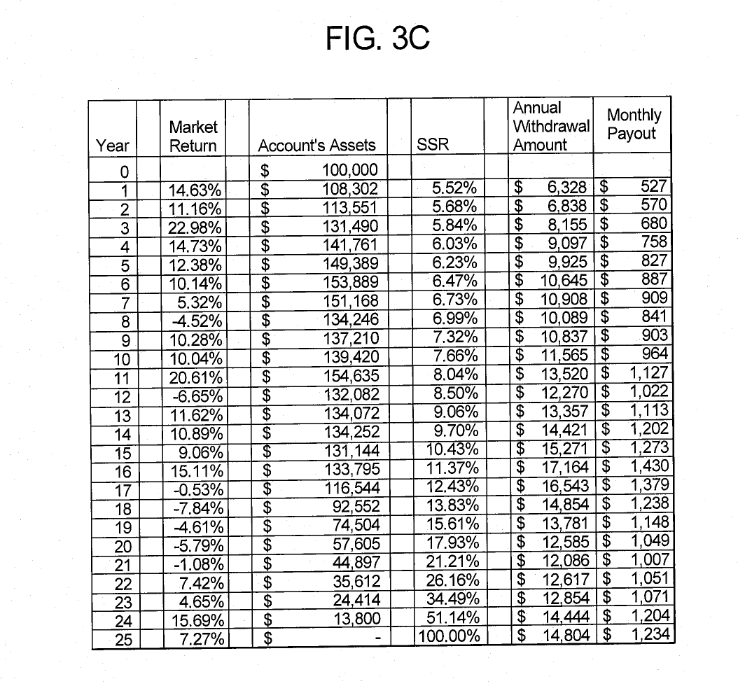

As illustrated in the example table of FIG. 3A, an investor invests $100,000 in a target spending portfolio at time 0. The portfolio is established for a term of twenty years. The market returns are simulated, and the SSR is calculated at the 60^{th} percentile confidence level. This example does not assume a qualitative overlay in the final years of the investment term.

In FIG. 3A, for the first year, the portfolio targets an SSR of 6.47% based on the spending rate that the portfolio should be able to sustain with the selected level of confidence until the end of the portfolio's term or the portfolio's final payout date. Using the determined SSR of 6.47%, the portfolio targets a payout for the first year of $6,473. After the first year, the portfolio produced a gain of 0.04%. Based on the portfolio's performance in the first year and the shorter investment horizon (i.e., the portfolio now has 19 years remaining in the term), the SSR is re-calculated at the end of the first year. The re-calculated SSR of 6.73% is applied to the next year. Thus, the portfolio targets a payout of $6,457 for the next year (i.e., the designated time period).

FIG. 3B illustrates an example table similar to the table of FIG. 3A. In the example table of FIG. 3B, however, the SSR is calculated at a 50^{th} percentile confidence level using the same simulated market path. Thus, there is a higher level of investment risk associated with the target spending portfolio of this example. Using an SSR of 6.86% for the first year, the portfolio targets a payout of $6,863. In the first year, the portfolio produced a gain of 0.04%. Based on the portfolio's performance in the first year and the shorter investment horizon, the SSR is re-calculated at the end of the first year at a 50^{th} percentile confidence level. The re-calculated SSR of 7.11% is applied to the next year.

It should be appreciated that the target spending method may be applied to any investment period and is not limited to a 20-year investment term, as described in the above examples. As illustrated in the table of FIG. 3C, an example target spending portfolio has a term of 25 years. In this example, the SSR is calculated at a 60^{th} percentile confidence level. The simulated market path is different from the examples of FIG. 3A and FIG. 3B. The SSR for the first year is 5.52%, targeting a payout of $6,328. In the first year, the portfolio produced a gain of 14.63%. Based on the portfolio's performance and the shorter investment horizon after the first year of the investment, the SSR is re-calculated. The recalculated SSR (i.e., 11.16%) is applied to the next year. This process is repeated until the 25^{th} year of the investment term. In the 25^{th} year, the SSR is set at 100%, such that after the annual payout is provided to the investor, the investment account will be depleted.

Accordingly, FIGS. 3A, 3B, and 3C illustrate how the target spending portfolio of the present disclosure provides investors with a disciplined withdrawal strategy designed to maximize consumption at a given probability level for a pre-specified period.

It should be appreciated that periodically (e.g., annually) adjusting the SSR reduces the risk of (1) running out of money by spending too much, and (2) spending too little by allowing for increased payouts to keep pace with inflation. The ability to increase both the payout rate and the dollar amount of the payout provides investors with protection against inflation. In certain other investment instruments, such as a single premium annuity, the payout rate is fixed and does not account for inflation.

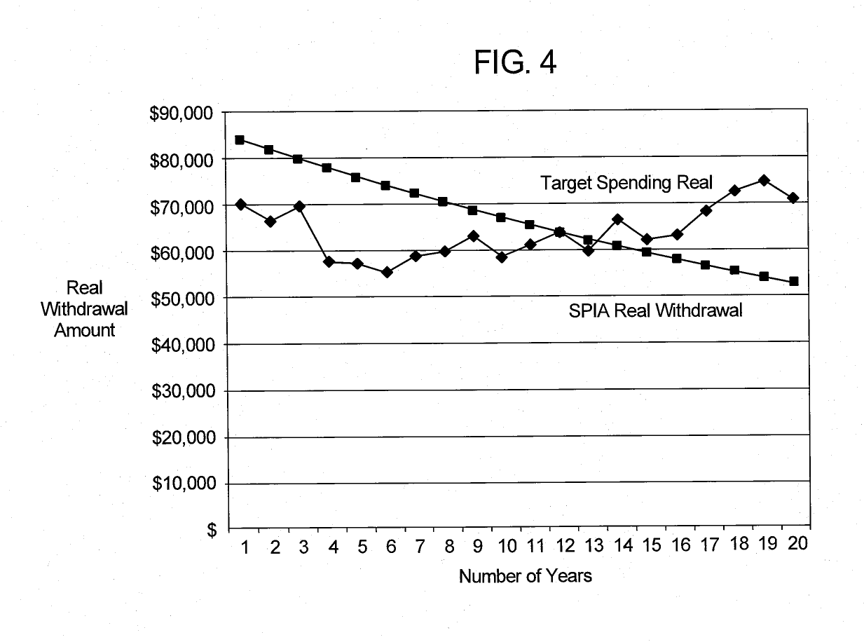

Referring now to FIG. 4, an example graph illustrates the ability of the target spending portfolio to maintain purchasing power over time compared to a single premium immediate annuity. In the single premium immediate annuity, regular payouts of a fixed amount are provided to the investor annually. However, inflation causes the annual payments to actually be worth less to the investor over time. In the target spending portfolio, on the other hand, the ability of the SSR to increase causes both the percent of the payout and the dollar amount of the payout to increase. Thus, investors have a cushion against inflation.

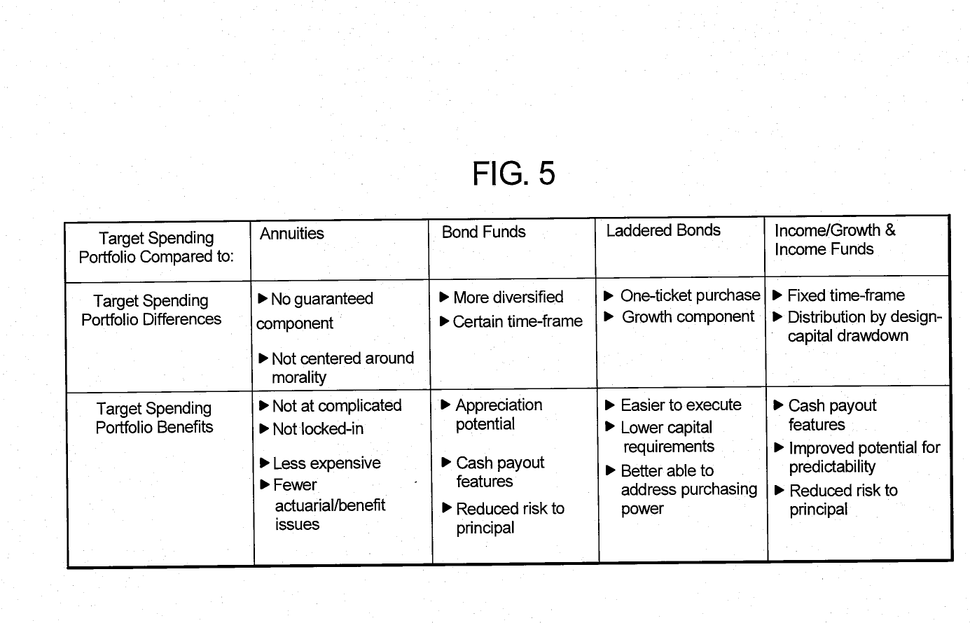

Referring now to FIG. 5, some key differences between other investment products and target spending portfolios are described. For example, unlike annuities, target spending portfolios have no guaranteed component. In certain embodiments, target spending portfolios are for a fixed term and need not be centered around mortality. In various alternative embodiments, target spending portfolios may be for variable periods of time or may be centered on mortality. As shown in FIG. 5, there are several benefits of target spending portfolios in comparison to annuities. For instance, target spending portfolios are not as complicated. Investors are not locked-in to the target spending portfolio and can exit and enter the portfolio at any time. In contrast, annuities are irrevocable. Annuities provide explicit guarantees, for which investors must pay fees. The stronger the guarantees, the higher the fees. Since target spending portfolios do not provide such guarantees, they are less expensive.

Target spending portfolios also involve fewer actuarial/benefit issues. In an annuity, for example, when an annuity holder dies, even if only a day after the holder began receiving payouts, the money belongs to the administrator (i.e., the insurance company). However, the assets of a target spending portfolio belong to the investor's beneficiaries when the investor dies. That is, the principal and earnings are returned to the investor's beneficiaries and are not forfeited to an insurance company. In one embodiment, when an investor dies, the target spending portfolio continues, and the investor's beneficiaries receive the periodic payouts until the final payout date. In another embodiment, the target spending portfolio terminates upon the death of investor, and the investor's beneficiaries receive the assets right away.

Unlike income funds, target spending portfolios are designed to pay back the investor's principal, as well as earnings. This payback feature better supports distribution planning. Since target spending portfolios pay back investors' assets and gains, these types of portfolios provide a more attractive method for sustaining purchasing power than yield-oriented investments. In addition, advisors and investors can more easily plan around the sustainable, steady payout feature of the target spending portfolio.

It should thus be appreciated that one embodiment of the present disclosure provides a computerized method of administering a target spending investment portfolio for an investor for a predetermined time period having a plurality of time intervals. For each time interval, at a designated time, a sustainable spending rate is determined based on a value of the target spending investment portfolio and an amount of time remaining in the predetermined time period. For each time interval, at least one payout is provided to the investor from the target spending investment portfolio based on the determined sustainable spending rate for that time interval. If necessary, for a final time interval, the investor is provided with any value of the target spending investment portfolio that has not been paid to the investor.

It should also be appreciated that another embodiment of the present disclosure provides a computerized method of providing sustainable spending rates to an administer of a target spending investment portfolio for an investor for a predetermined time period having a plurality of time intervals. In one such embodiment, for each time interval, at a designated time, a sustainable spending rate is calculated based on a value of the target spending investment portfolio and an amount of time remaining in the predetermined time period. For each time interval, the calculated sustainable spending rate is provided or communicated to the administrator to enable the administrator to make at least one payout from the target spending investment portfolio to the investor based on the determined sustainable spending rate for the time interval.

It should further be appreciated that one embodiment of the present disclosure provides a method of administering an investment portfolio, the method comprising: (a) receiving an agreement between an administrator and an investor which establishes the investment portfolio for a designated time period; (b) receiving designated information from the investor, if necessary; (c) establishing an investment account for holding funds for the benefit of the investor; (d) receiving funds from the investor and depositing the funds into the investment account to create a current investment account value; (e) investing the deposited funds; (f) for a first designated time interval, determining a sustainable spending rate based on the current investment account value and an amount of time remaining in the designated period of time; (g) providing at least one payout to the investor from the investment account based on the determined sustainable spending rate; (h) determining an actual performance rate for the investment portfolio; (i) re-calculating the sustainable spending rate based on the actual performance rate of the investment portfolio and an amount of time remaining in the designated time period; (j) applying the re-calculated sustainable spending rate to a next designated time interval to determine the at least one payout to be provided to the investor for the next designated time interval; (k) repeating (g) to (j) until a final designated time interval; (l) for the final designated time interval, determining a final payout amount to be provided to the investor such that, after the final payout amount is provided to the investor, the investment account value is zero; and (m) providing the final payout to the investor.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of administering a target spending investment portfolio for an investor for a designated time period having a plurality of time intervals, said method comprising:
(a) for each time interval, at a designated time, determining a sustainable spending rate based on a value of the target spending investment portfolio and an amount of time remaining in the designated time period;
(b) for each time interval, providing at least one payout from the target spending investment portfolio to the investor based on the determined sustainable spending rate for said time interval; and
(c) if necessary, for a final time interval, providing the investor any value of the target spending investment portfolio not paid to the investor.

2. The method of claim 1, wherein the target spending investment portfolio is administered by a first entity, and wherein determining the sustainable spending rate for each time interval includes obtaining the sustainable spending rate for each time interval from a second different entity.

3. The method of claim 1, which includes for each time interval after the first interval determining an actual performance rate for the target spending investment portfolio, and determining the sustainable spending rate for the subsequent time interval based on the actual performance rate of the target spending investment portfolio.

4. The method of claim 1, wherein each time interval includes a year.

5. A method of providing sustainable spending rates to an administer of a target spending investment portfolio for an investor for a designated time period having a plurality of time intervals, said method comprising:
(a) for each time interval, at a designated time, calculating a sustainable spending rate based on a value of the target spending investment portfolio and an amount of time remaining in the designated time period; and
(b) for each time interval, providing said calculated sustainable spending rate to the administrator to enable the administrator to make at least one payout from the target spending investment portfolio to the investor based on the determined sustainable spending rate for said time interval.

6. The method of claim 5, which includes for each time interval after the first interval, determining an actual performance rate for the target spending investment portfolio, and re-calculating the sustainable spending rate for the subsequent time interval based on the actual performance rate of the target spending investment portfolio.

7. The method of claim 5, which includes formulating estimates of any risks associated with each asset of the target spending investment portfolio.

8. The method of claim 7, which includes calculating the sustainable spending rate for each time interval based said estimates of risk.

9. A method of administering an investment portfolio, said method comprising:
(a) receiving an agreement between an administrator and an investor which establishes the investment portfolio for a designated time period;
(b) receiving designated information from the investor, if necessary;
(c) establishing an investment account for holding funds for the benefit of the investor;
(d) receiving funds from the investor and depositing said funds into the investment account to create a current investment account value;
(e) investing the deposited funds;
(f) for a first designated time interval, determining a sustainable spending rate based on the current investment account value and an amount of time remaining in the designated period of time;
(g) providing at least one payout to the investor from the investment account based on the determined sustainable spending rate;
(h) determining an actual performance rate for the investment portfolio;
(i) re-calculating the sustainable spending rate based on the actual performance rate of the investment portfolio and an amount of time remaining in the designated time period;
(j) applying the re-calculated sustainable spending rate to a next designated time interval to determine the at least one payout to be provided to the investor for said next designated time interval;
(k) repeating (g) to (j) until a final designated time interval;
(l) for the final designated time interval, determining a final payout amount to be provided to the investor such that, after the final payout amount is provided to the investor, the investment account value is zero; and
(m) providing the final payout to the investor.

10. The method of claim 9, wherein the investment portfolio is administered by a first entity, and wherein determining the sustainable spending rate for each time interval includes obtaining the sustainable spending rate for each time interval from a second different entity.

11. The method of claim 9, wherein each designated time interval includes a year.
